(19) United States
(12) Patent Application Publication
(10) Pub. No.: US 2001/0034636 A1
(43) Pub. Date: Oct. 25, 2001

(54) Merchandise order apparatus and method thereof, and recording medium

(76) Inventors: Yasuaki Ikemura, Akita (JP); Akira Watanabe, Akita (JP); Mitsugi Saito, Akita (JP)

Correspondence Address: STAAS & HALSEY LLP, 700 11TH STREET, NW, SUITE 500, WASHINGTON, DC, 20001, US

(21) Appl. No.: 09/772,922

(22) Filed: Jan. 31, 2001

(30) Foreign Application Priority Data
Apr. 19, 2000 (JP) 2000-118607

(51) Int. Cl. G06F 17/60

(52) U.S. Cl. 705/10; 705/26; 705/28

(57) ABSTRACT

An apparatus for ordering merchandise is provided with a receiving unit receiving an order signal including remainder quantity information that shows the remainder quantity of merchandise; prediction period calculation unit calculating a period until the remainder quantity of merchandise is exhausted; order information preparation unit selecting the shop where the merchandise can be purchased most cheaply based on the calculated period and the selling price of the merchandise, and preparing order information based on the selection; and order unit ordering the merchandise from the shop that is selected based on the order information. Thus, the present invention realizes a process of automatically placing an order, in such a way that merchandise can be purchased most cheaply before the merchandise is exhausted, with regard to the merchandise of which the selling price differs between every shop.

### BACKGROUND OF THE INVENTION

1. Field of the Invention

The present invention relates to a merchandise order apparatus. It especially refers to a merchandise order apparatus for monitoring the remainder quantity of merchandise and for enabling a purchaser to order the merchandise before the remainder quantity is exhausted.

2. Description of the Related Art

Regarding the above-mentioned technical fields, an oil merchandise supply system and fluid merchandise order and receiving system are disclosed in Japanese patent laid-open Publication No. Hei 1-320568, Japanese patent laid-open Publication No. Hei 9-24999, and Japanese patent laid-open Publication No. Sho 62-95696.

According to these technologies, a purchaser makes a contract with a particular shop beforehand, and the remainder quantity of merchandise is monitored through a network such as a telephone line, etc., at a place where the merchandise is consumed, so that the merchandise is automatically ordered from the shop when the remainder quantity drops below a fixed quantity.

As for another conventional technology, a remainder oil quantity monitoring system of the fuel tank used for greenhouse cultivation, and a fuel oil delivery method are disclosed in Japanese patent laid-open Publication No. Hei 10-213472 and Japanese patent laid-open Publication No. Sho 63-82995. According to these technologies, when the remainder quantity of fuel drops below a fixed quantity at a place where the fuel is consumed, notification of this fact is issued to the monitoring center of a specific shop through a network. Therefore, the shop can carry out a rational and scheduled delivery based on the notification received at the monitoring center.

In the conventional technologies, however, there is such a problem that since an automatic order is made only to a certain specific shop, a purchaser can neither select nor place an order with a shop from a plurality of shops. Therefore, merchandise, such as kerosene or the like, the selling price of which differs at each shop, can not be purchased most cheaply.

### SUMMARY OF THE INVENTION

An object of the present invention is to solve the above-mentioned problem, and to make an automatic order to a shop where merchandise can be purchased most cheaply in consideration of the selling price at each shop, where the selling price differs at each shop.

To solve the above-mentioned problem, according to the present invention, a merchandise order apparatus is provided with a receiving unit receiving an order signal including the remainder quantity information that shows the remainder quantity of merchandise; a prediction period calculation unit calculating a prediction period that is a period until the remainder quantity of merchandise is exhausted, based on the purchaser's purchase history and remainder quantity information; an order information preparation unit selecting the shop where merchandise can be purchased most cheaply based on the prediction period and the selling price of merchandise, thereby preparing order information based on the decision; and an order unit making an order to the selected shop based on the order information.

The receiving unit receives an order signal including the remainder quantity information of merchandise. The prediction period calculation unit calculates a prediction period before the remainder quantity of merchandise is exhausted, based on the remainder quantity information, and the purchaser's purchase history. The order information preparation unit selects the shop where merchandise can be purchased most cheaply based on the prediction period and the selling price of the merchandise. The order unit places an order with the thus-selected shop.

In this way, it becomes possible to make an automatic order so as to purchase merchandise most cheaply before the remainder quantity of merchandise is exhausted.

Here, the order information preparation unit may select the purchase day and shop when and where merchandise can be purchased most cheaply, taking into consideration the delivery charge within the prediction period. The order unit may place an order with a shop that is selected as a shop where the merchandise can be purchased on the selected purchase day.

The order information preparation unit compares selling prices of the respective shops within the prediction period, and selects the purchase day and shop when and where the merchandise can be purchased most cheaply, taking into consideration the delivery charge. Then, based on the selection, the order unit places an order so as to purchase the merchandise on the purchase day.

In this way, it becomes possible to automatically order merchandise from the shop where the merchandise can be purchased most cheaply, taking into consideration the delivery charge on the day when the merchandise can be purchased most cheaply before a remainder quantity of the merchandise is exhausted, based on the order signals.

The order information preparation unit may select a purchase day and shop, taking into consideration the day to day fluctuation of a selling price. In this way, in the case that the selling price of merchandise differs between shops or even in the case that the selling price differs from day to day at the same shop, it becomes possible to select the purchase day and shop when and where merchandise can be purchased most cheaply, taking into consideration the delivery charge.

The prediction period calculation unit calculates a prediction period by taking into consideration the seasonal change and purchase history. For example, in the case that the merchandise is kerosene for heating or the like, the consumption rate gradually declines as the season changes from spring to summer. The prediction period calculation unit calculates the prediction period by taking into consideration the fluctuation trend of such a consumption rate based on the purchase history and the other trends, thereby giving high precision to the prediction period.

In the case that remainder quantity information shows that the remainder quantity of merchandise is exhausted, the prediction period calculation unit sets the prediction period as the shortest period, and immediately places an order.

The merchandise order apparatus may be further provided with a prediction order quantity calculation unit calculating a prediction order quantity based on the prediction period, purchase history, and remainder quantity information. The order unit notifies the selected shop of the prediction order quantity when the merchandise is ordered.

The prediction order quantity calculation unit calculates a prediction order quantity by calculating how much of the merchandise was consumed before the unit receives an order signal based on the remainder quantity information, and how much the remainder quantity of the merchandise will be consumed before the merchandise is derivered based on the purchase history. Then, the order unit issues notification of this prediction order quantity to the shop. In this way, the shop can easily make a sales plan.

In the case that the remainder quantity information shows that the remainder quantity of merchandise is exhausted, the prediction order quantity calculation unit may set the prediction order quantity to be a storage capacity of the merchandise storage container of a purchaser.

The receiving unit may receive the above-mentioned order signal when the remainder quantity of merchandise becomes a predetermined quantity and also when the remainder quantity is exhausted. The merchandise may also be fluid merchandise.

The scope of the present invention includes a method that consists of processes performed by the above-mentioned apparatus. Furthermore, the scope of the present invention includes a recording medium for recording a program that enables a computer to perform the above-mentioned processes.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 is a drawing showing the principle configuration of the present invention;

FIG. 2 is a drawing showing the function configuration of a merchandise order apparatus;

FIG. 3 is a drawing showing the function realized by the merchandise order apparatus;

FIG. 4 is a drawing showing an example of the data structure of a telephone number table;

FIG. 5 is a drawing showing an example of the data structure of a purchaser database;

FIG. 6 is a drawing showing an example of the data structure of a purchase history file;

FIG. 7 is a drawing showing an example of the data structure of a shop database;

FIG. 8 is a drawing showing an example of the data structure of an area database;

FIG. 9 is a drawing showing an example of the data structure of an order database;

FIG. 10 is a flowchart showing processes performed till a prediction period and prediction order quantity are calculated after an order signal is received;

FIG. 11 is a drawing showing the relationship between a merchandise remainder quantity and a prediction period.

FIG. 12 is a flowchart showing processes of preparing order information;

FIG. 13 is a flowchart showing order processes;

FIG. 14 is a drawing showing an example of order information for a shop;

FIG. 15 a flowchart showing processes of acquiring shop information and updating an area database;

FIG. 16 is a drawing showing the configuration of an information processor; and

FIG. 17 is a drawing showing a computer-readable transmission signal and transmission medium being able to supply a program and data to a computer.

### DESCRIPTION OF THE PREFERRED EMBODIMENTS

The following is an explanation of the embodiments of the present invention in reference to the drawings.

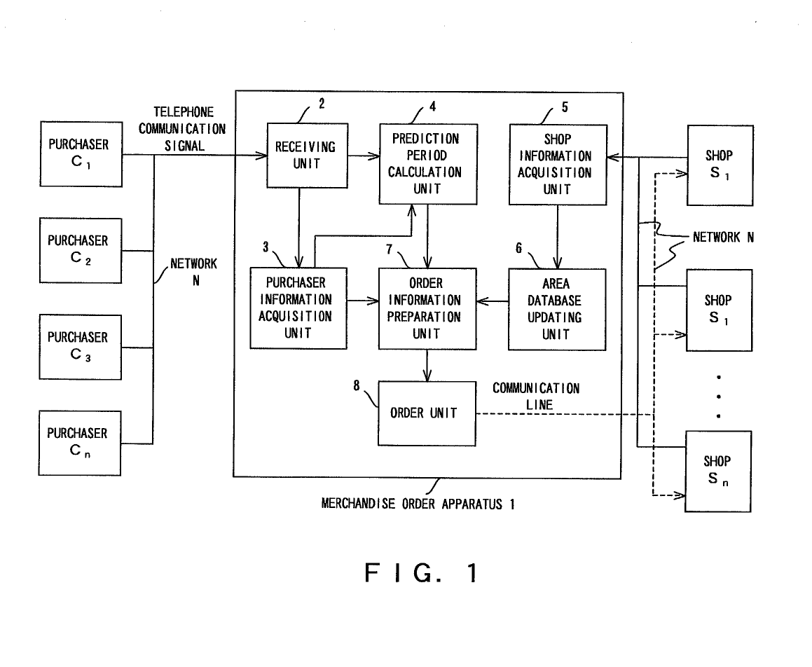

FIG. 1 is a drawing showing the principle configuration of the present invention. As shown in FIG. 1, the merchandise order apparatus 1 is provided with a receiving unit 2, purchaser information acquisition unit 3, prediction period calculation unit 4, shop information acquisition unit 5, area database updating unit 6, order information preparation unit 7, and order unit 8. The merchandise order apparatus 1 is connected with purchasers C1 and C2 to Cn, and shops S1 and S2 to Sn, through a network N. As the network N, a public line, exclusive line, etc., for example, are conceivable.

The receiving unit 2 receives an order signal from each purchaser Ci (i is an optional integer from 1 to n) through the network N. Here, the order signal is determined to be received before a purchaser completely consumes the merchandise, for example when the remainder quantity of the merchandise becomes half or completely consumed.

The purchaser information acquisition unit 3 acquires the purchaser information that is information about a purchaser who sends the order signal, in reference to the database that is not shown in the drawings, based on the received order signal. The prediction period calculation unit 4 calculates the prediction period being a period until a remainder quantity of the merchandise is completely consumed, based on the remainder quantity of merchandise and the purchase history of the purchaser. In the case that the remainder quantity of merchandise is exhausted, the prediction period calculation unit 4 sets the prediction period to the shortest period.

The shop information acquisition unit 5 acquires shop information concerning the selling price of merchandise and the delivery charge for delivering the merchandise to a purchaser, from each shop Si. The shop information is acquired regularly or irregularly. The area database updating unit 6 updates the area database that is obtained by editing the obtained shop information for each area, based on the latest shop information.

The order information preparation unit 7 selects a purchase day and shop, so that the merchandise can be purchased most cheaply, taking into consideration, the delivery charge is, by the time the remainder quantity of merchandise is exhausted, based on the purchaser information, prediction period, and shop information. Then, the order information preparation unit 7 prepares order information based on the selection. The order unit 8 orders the merchandise from a shop where the merchandise is to be purchased based on the order information through the network N.

In this way, in the case that an order signal is received from a purchaser before the purchaser completely consumes the merchandise, the merchandise order apparatus 1 selects the day and shop when and where the merchandise can be purchased most cheaply before a remainder quantity of the merchandise is exhausted, and the apparatus 1 orders the merchandise from the shop. When a shop is selected, the delivery charge to be charged for delivering the merchandise to a purchaser is also taken into consideration together with the selling price of the merchandise. In this way, the purchaser can automatically purchase the supplemental merchandise most cheaply before the merchandise is exhausted.

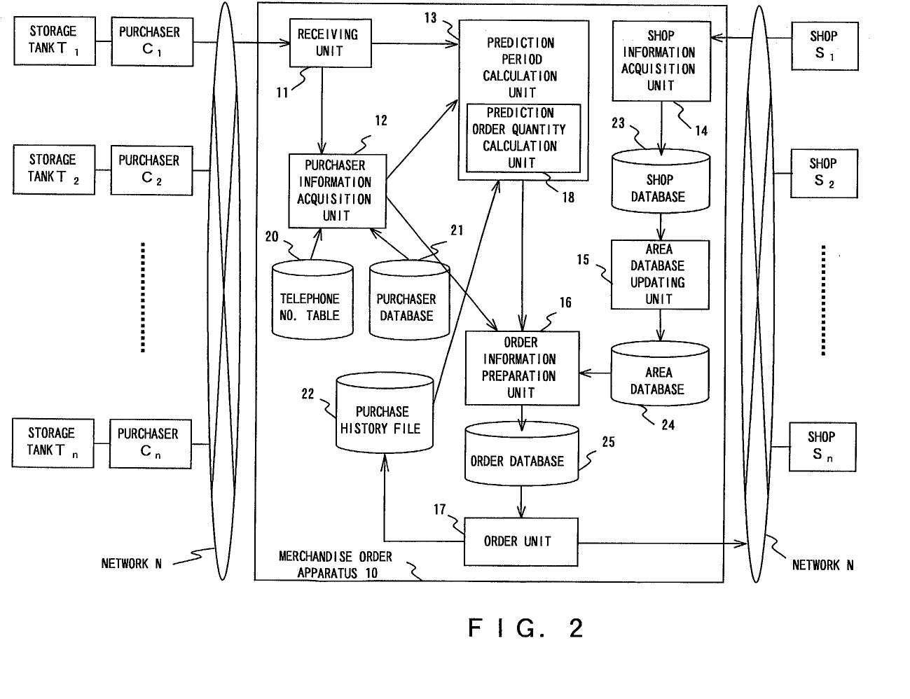

FIG. 2 is a diagram showing the function configuration of a merchandise order apparatus 10 that is related to the present embodiments. As shown in FIG. 2, the merchandise order apparatus 10 is provided with a receiving unit 11, purchaser information acquisition unit 12, prediction period calculation unit 13, shop information acquisition unit 14, area database updating unit 15, order information preparation unit 16, order unit 17, telephone number table 20, purchaser database 21, purchase history file 22, shop database 23, and area L database 24. The merchandise order apparatus 10 and purchaser Ci are connected through the network N while the merchandise order apparatus 10 and shop Si are connected through the network N. Each network N is separately illustrated in the drawing, but it does not matter whether one network N is provided or two networks N are provided. As the network N, a WAN (Wide Area Network) such as a satellite communication network and the Internet, a LAN (local area network), etc., are conceivable. Each purchaser Ci is provided with a storage tank Ti for storing merchandise.

The receiving unit 11 receives the order signal for ordering merchandise from the purchaser Ci, and outputs the received order signal to the purchaser information acquisition unit 12 and prediction period calculation unit 13. The order signal includes information, for example, telephone numbers and the remainder quantity of merchandise. More specifically, the order signal is transmitted together with the remainder quantity information which shows the remainder quantity at each timing, for example, when the remainder quantity of the storage tank Ti provided by each purchaser Ci becomes half or 0 (zero). In the case of fluid merchandise, for example, the remainder quantity is obtained by detecting the height of the surface of fluid stored inside the storage tank Ti.

The purchaser information acquisition unit 12 specifies the purchaser Ck (k is an optional integer from 1 to n) who sends an order signal, based on the order signal, acquires the information regarding the purchaser Ck, for example, the address, name, etc., and outputs the information to the prediction period calculation unit 13 and order information preparation unit 16. Specifically, in the case that the order signal is transmitted through a telephone line, the purchaser information acquisition unit 12 extracts the telephone number of the purchaser Ck from the order signal. Subsequently, the purchaser information acquisition unit 12 acquires purchaser information about the name, address and the like of the purchaser Ck who sends the order signal, in reference to the telephone number table 20 and purchaser database 21, based on the telephone number.

The order signal may not be transmitted through a telephone line, and it may be transmitted through E-mail, for example. In the case of E-mail, purchaser information maybe acquired, for example based on the E-mail address.

The prediction period calculation unit 13 acquires the remainder quantity of merchandise based on the order signal, and acquires the purchase history of a purchaser in reference to the purchase history file 12 using the purchaser number. Subsequently, the prediction period calculation unit 13 calculates the prediction period before the merchandise remainder quantity is exhausted, based on the acquired remainder quantity and purchase history. The prediction period calculation unit 13 sets the prediction period to the shortest period, in the case that the remainder quantity is 0 (zero). Subsequently, the prediction period calculation unit 13 outputs the calculated prediction period to the order information preparation unit 16.

The prediction period calculation unit 13 may be further provided with a prediction order quantity calculation unit 18. The prediction order quantity calculation unit 18 calculates the prediction order quantity that is a predicted merchandise purchase quantity, based on the merchandise remainder quantity, calculated prediction period, and purchase history of a purchaser. This prediction order quantity is transmitted to a shop where merchandise is to be purchased, at the time of making an order. In this way, each shop Si can easily make a sales plan.

The shop information acquisition unit 14 acquires information with regard to the selling price of merchandise and delivery charge to each area from each shop Si, and prepares the shop database 23. The shop information acquisition unit 14 acquires the latest information regularly, for example every day, or irregularity from each shop Si. The area database updating unit 15 updates the area database 24 based on the latest shop database 23. The contents of the area database 24 are obtained by editing the information of the shop database 23 for each area.

The order information preparation unit 16 selects a shop Sm (m is an optional integer from 1 to n) and purchase day where and when the ordered merchandise is sold most cheaply within the prediction period, by referring to the area database 24 and considering the delivery charge of the merchandise. Subsequently, the order information preparation unit 16 makes an order database 25 for storing the selected purchase day, selected shop Sm, calculated prediction order quantity, and information regarding the purchaser Ck who sends the order signal.

The order unit 17 orders merchandise from the selected shop Sm based on the data of the order database 25, so that the merchandise can be purchased on the selected day. After the merchandise is ordered, the order unit 17 updates the contents of the purchase history file 22 based on the order database 25.

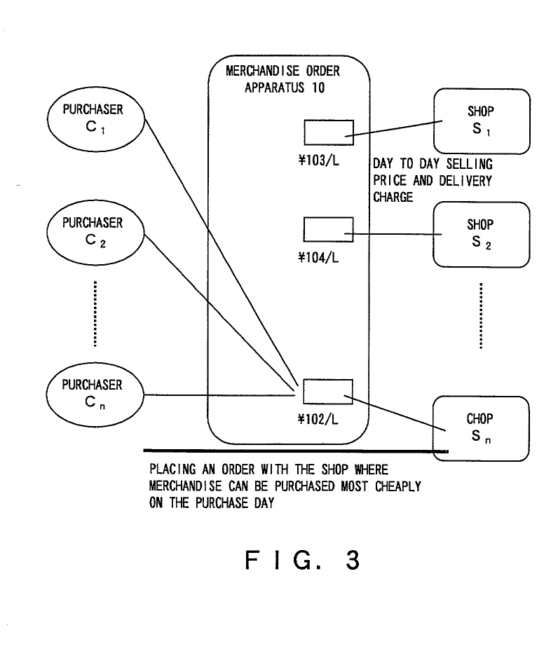

FIG. 3 is a drawing explaining the functions performed by the merchandise order apparatus 10. The merchandise order apparatus 10 is connected with the purchaser Ci and shop Si. The merchandise order apparatus 10 acquires from each shop Si, the selling price of merchandise which fluctuates every day and the delivery charge for delivering the merchandise to each area. When the merchandise order apparatus 10 receives an order signal from each purchaser Ci, it selects the shop and purchase day where and when the ordered merchandise can be purchased most cheaply, based on the selling price and delivery charge, and it orders the merchandise from the selected shop.

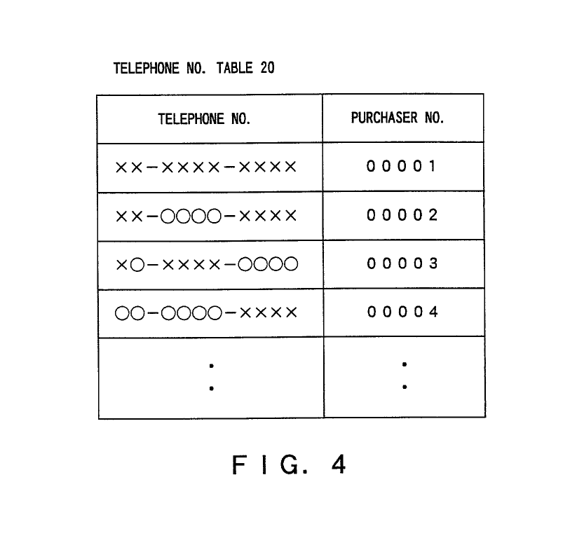

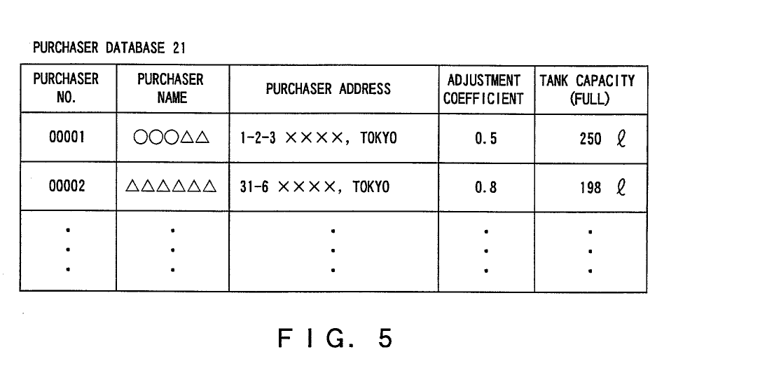

Below is an explanation of the data structure of each database using FIGS. 4 to 9. FIG. 4 shows an example of the data structure of the telephone number table 20. The telephone number table 20 stores telephone numbers and the purchaser numbers corresponding to the telephone numbers. Each of the purchaser numbers is specific to each purchaser Ci. FIG. 5 shows an example of the data structure of the purchaser database 21. The purchaser database 21 stores a purchaser number, purchaser name, purchaser address, adjustment coefficient K, and tank capacity Vi that is a capacity of the storage tank Ti provided by each purchaser Ci. The adjustment coefficient K will be described later.

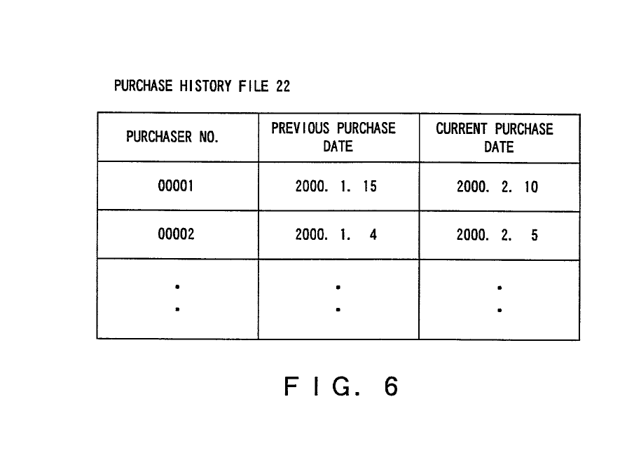

FIG. 6 shows an example of the data structure of the purchase history file 22. The purchase history file 22 stores the purchaser number, previous purchase date the merchandise was purchased, and present purchase date the merchandise is purchased.

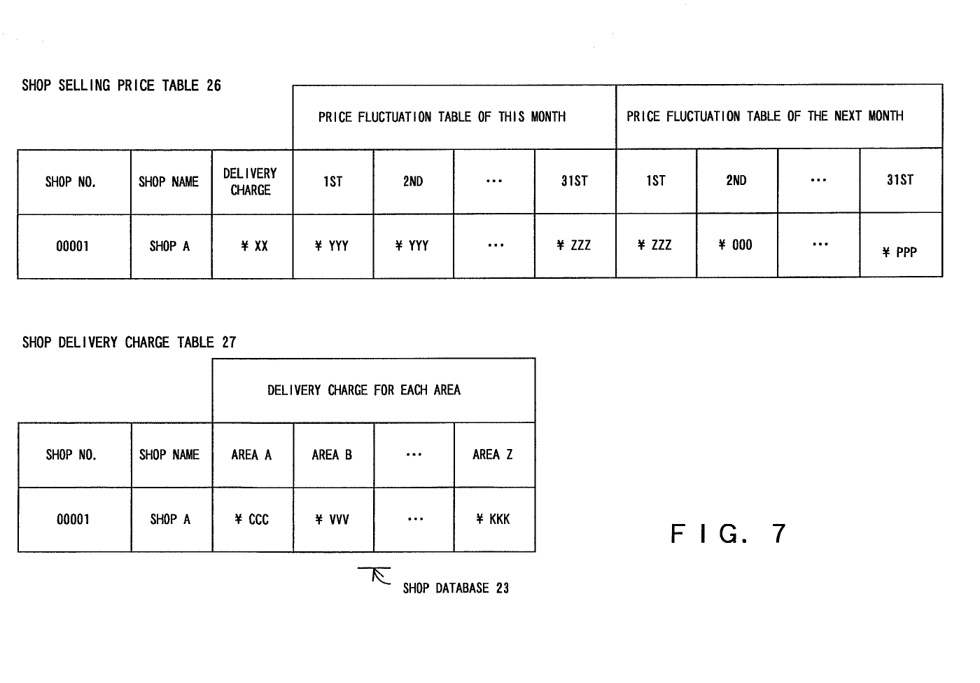

FIG. 7 shows an example of the data structure of the shop database 23. The shop database 23 includes a shop selling price table 26 and shop delivery charge table 27, and it is provided with each shop Si. The shop database 23 is regularly or irregularly updated based on the information transmitted from each shop Si. The shop selling price table 26 stores the selling price of merchandise to be sold by each shop Si every day (per one unit quantity). For example, the selling prices to be stored are those for this month and also the next month. The selling price for the next month is a reflection of the sales strategy of each shop Si. The shop delivery charge table 27 stores the delivery charge of each shop Si for delivering the merchandise to each area.

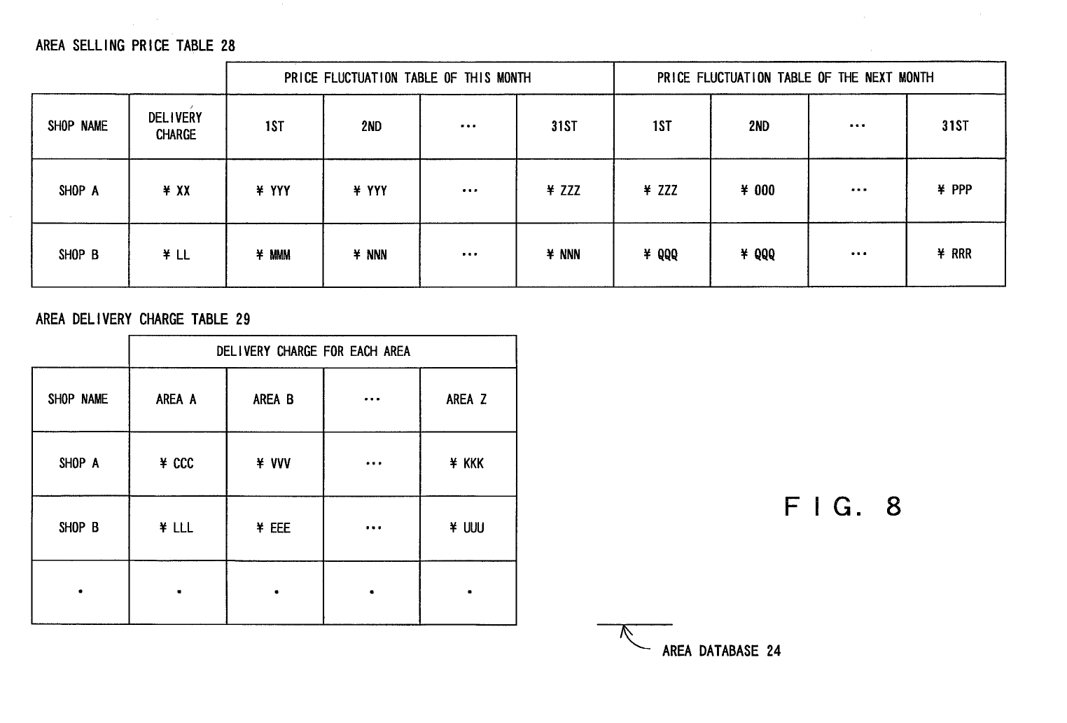

FIG. 8 shows an example of the data structure of the area database 24. The area database 24 includes an area shop table 28 and area delivery charge table 29. The area database 24 is regularly or irregularly updated by the area database updating unit 6 based on the latest shop database 23. The contents of the area database 24 are obtained by editing the contents of the shop database 23.

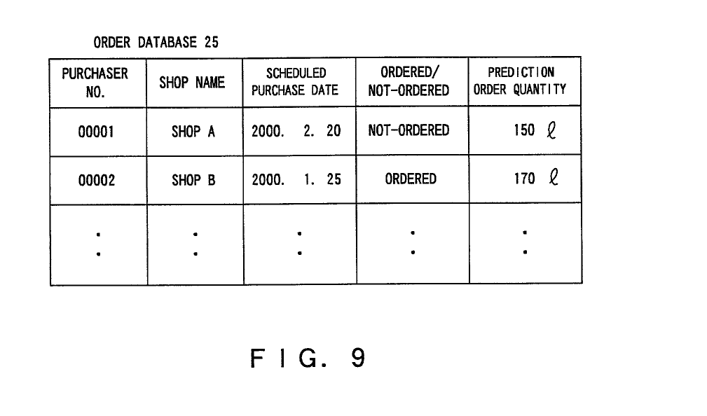

FIG. 9 shows an example of the data structure of the order database 25. The order database 25 is prepared by the order information preparation unit 7, and stores a purchaser number, shop name, purchase day, information about whether the merchandise is ordered, and prediction order quantity.

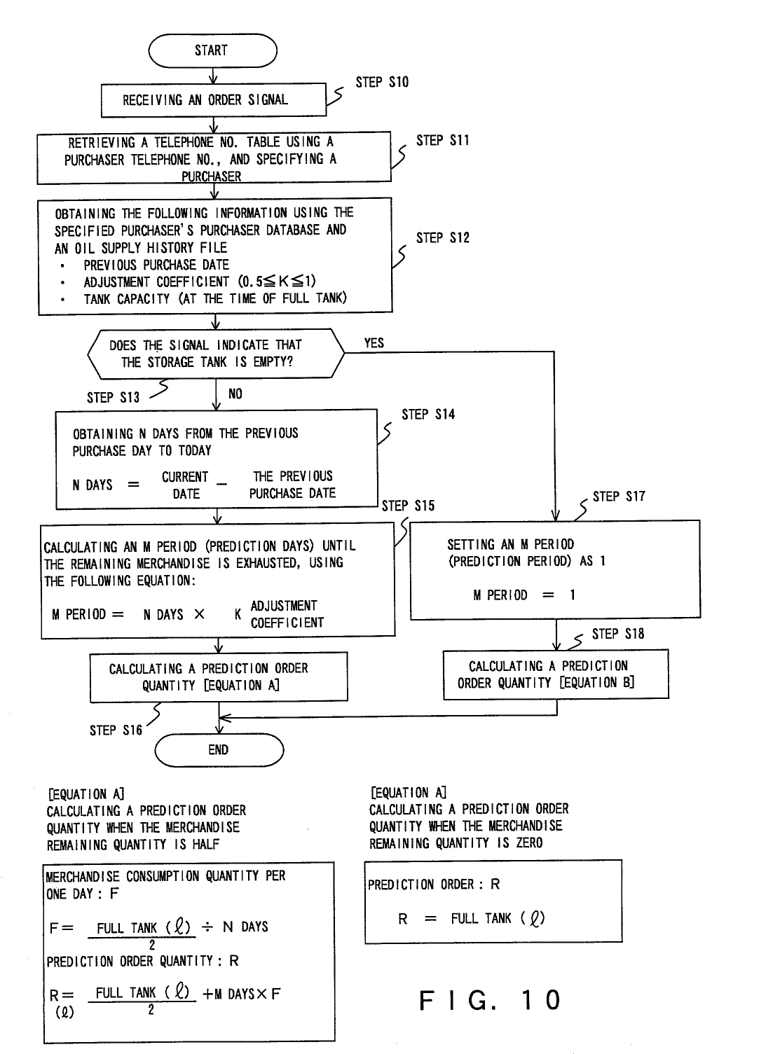

Below is an explanation, using FIGS. 10 to 15, of processes performed by the merchandise order apparatus 10. The merchandise order apparatus 10 calculates a prediction period and prediction order quantity in reference to the various kinds of databases after receiving an order signal, and it selects the purchase day and shop when and where the ordered merchandise can be purchased most cheaply taking into consideration the delivery charge. Then, the apparatus 10 orders merchandise from the selected shop, so that the merchandise can be purchased on the purchase day based on this selection. FIG. 10 is a flowchart showing processes to be performed before the prediction period and prediction order quantity are calculated after the order signal is received. Below is an explanation of processes to be performed before the merchandise order apparatus 10 calculates the prediction period and prediction order quantity after it receives the order signal, using FIG. 10.

The receiving unit 11 receives the order signal from the purchaser Ci (step 10). The purchaser information acquisition unit 12 extracts the telephone number of a purchaser who sends the order signal, from the order signal, and it specifies the purchaser who sends the order signal, from the purchaser number, by referring to the telephone number table 20 while using the extracted telephone number. Assume that the purchaser Ck has been specified.

Subsequently, the purchaser information acquisition unit 12 acquires the name and address of the specified purchaser Ck, adjustment coefficient K, and capacity Vk of the storage tank Tk, in reference to the purchaser database 21 using the purchaser number (step S12).

The order signal is transmitted when the remainder quantity of merchandise becomes a predetermined capacity of the storage tank Tk, for example when the remainder quality of merchandise becomes half or 0 (zero), and the order signal includes the remainder quantity information showing the remainder quantity of merchandise. For example, a pattern of the order signal may be used as remainder quantity information. Therefore, it is possible to show the remainder quantity of merchandise, by changing the pattern of the order signal when the remainder quantity of merchandise is half to another pattern when the remainder quantity of merchandise becomes 0 (zero). In addition, a numerical value, for example, may be used as remainder quantity information.

The prediction period calculation unit 13 acquires the remainder quantity of merchandise based on the order signal, and selects whether the storage tank Tk of the purchaser Ck is empty (step S13). In the case that the storage tank Tk is not empty, half of the merchandise is left in the storage tank Tk (step S13: No). The prediction period calculation unit 13 calculates a prediction period M before the remainder quantity of merchandise is exhausted, as follows:

First, the prediction period calculation unit 13 acquires the previous purchase day of a purchaser Ck in reference to the purchase history file 22, and calculates a period N between the previous purchase day and the day when the order signal is received (step S14) Subsequently, the prediction period calculation unit 13 calculates the prediction period M that is a period before the remainder quantity of merchandise is exhausted using the period N and adjustment coefficient K, by the following equation (1):

M=N×K (1)

Next, the prediction order quantity calculation unit 18 provided with the prediction period calculation unit 13 calculates a prediction order quantity (step S16). In the case that the remainder quantity of merchandise is half of the capacity Vk of the storage tank Tk (step S13: No), a merchandise consumption amount F per one day is calculated by the following equation (2):

F=Vk/(2×N) (2)

Subsequently, the prediction order quantity calculation unit 18 calculates a prediction order quantity R by the following equation (3):

R=Vk/2+(M×F) (3)

An equation (4) can be obtained, when equations (1) and (2) are substituted into the equation (3).

R=Vk(1+K)/2 (4)

However, in the case that the prediction period calculation unit 13 determines that an order signal has been transmitted when the storage tank Tk is empty (step S13: Yes), the merchandise should be immediately supplied to the purchaser Ck since there is no remainder quantity of merchandise. Accordingly, the prediction period calculation unit 13 sets the prediction variation period M to the shortest period “1” (step S17).

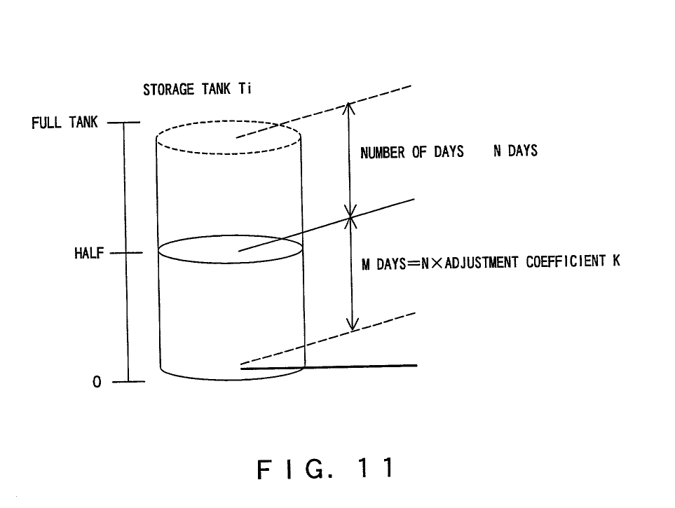

Then, since the storage tank Tk is empty (step S18), the prediction order quantity calculation unit 18 sets the prediction order quantity as the tank capacity Vk,. Here, the relationship between the adjustment coefficient K and prediction period M I is explained using FIG. 11.

FIG. 11 shows the relationship between the adjustment coefficient K and prediction period M. A vertical axis shows the storage tank capacity shown in FIG. 11. An order signal is transmitted when the remainder quantity of merchandise of a storage tank Ti is half or empty. When merchandise is supplied, the storage tank Ti becomes full.

Here, assume that the receiving unit 11 receives an order signal when the remainder quantity of merchandise of the storage tank Ti is half. A period N between the previous purchase day and the day when an order signal is received is a period between the time when the storage tank is full of merchandise and the time when half the merchandise in the storage tank is consumed. Therefore, it is assumed that a prediction period M that is a period until the half-remaining merchandise is completely consumed, is approximately the same as the period N.

The adjustment coefficient K is a numerical value to be used for taking into consideration the season variation, purchase history variation, request of the purchaser Ci, etc., when the prediction period M is calculated. The adjustment coefficient K is a variable or constant in the range of 0.5<=K<=1.

In the case that the merchandise is kerosene for heating, for example, the consumption pace will fall when the season is changing from spring to summer. In this case, the prediction variation period M can be calculated in accordance with the change of the consumption pace, by setting the adjustment coefficient K to a larger value.

In the case that the consumption pace is large every year at a certain period in a year, for example New Year, the adjustment coefficient K is set to a small value. If there is a requirement to absolutely avoid running out of stock, the coefficient K is set to be a small value so that a shorter prediction variation period M can be calculated. By introducing the adjustment coefficient K, it becomes possible to incorporate appropriate safety margin and also precision into the prediction period M.

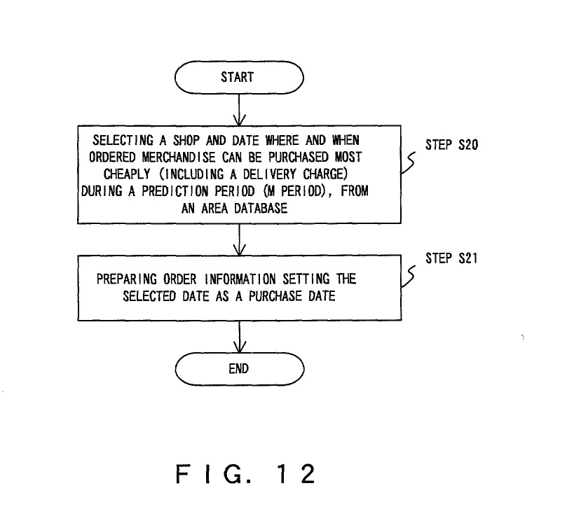

In this way, after the prediction period M and prediction order quantity R are calculated, order information is prepared. FIG. 12 is a flowchart showing the processes of preparing order information. Below is an explanation, using FIG. 12, of processes for preparing order information.

The order information preparation unit 16 selects the shop that represents the cheapest selling price and the purchase day when merchandise can be purchased most cheaply, within the prediction period M calculated by the prediction period calculation unit 13 taking into consideration the delivery charge, in reference to the area database 24(step S20).

More concretely, the order information preparation unit 16 acquires the selling price at each shop Si every day within the prediction period M after the day when an order signal is received, in reference to the area selling price table 28. Furthermore, the order information preparation unit 16 acquires the delivery charge to be charged for delivering the merchandise to the area of the purchaser Ck from each shop, based on the address of the purchaser Ck.

Based on the selling price and delivery charge, the order information preparation unit 16 sets the day when the merchandise can be purchased most cheaply as a purchase day, within the prediction period M, and selects the shop where merchandise can be purchased most cheaply. That is, the order information preparation unit 16 selects as a purchase day the day when merchandise can be purchased most cheaply between the day when an order signal is received and the day when the prediction period M has passed, in consideration of the fluctuation of the every-day selling price and the delivery charge. Here, assume that the order information preparation unit 16 selects a shop Sm as a shop from which merchandise is ordered.

Subsequently, the selected shop Sm, selected purchase day, name and address of the purchaser Ck who sends the order signal, and prediction order quantity R calculated by the prediction order quantity calculation unit 18 are stored in the order database 25 (step S21).

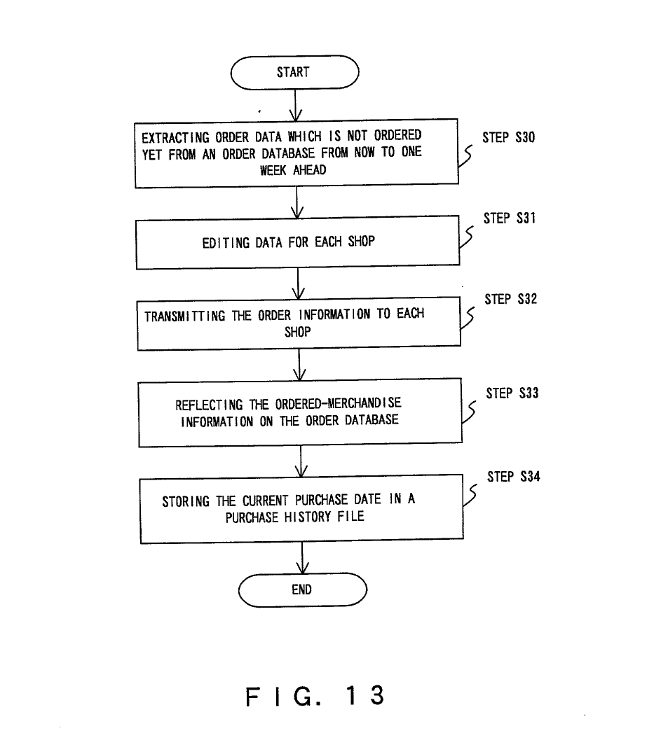

FIG. 13 is a flowchart showing order processes. The order processes performed after the order database is prepared, are explained using FIG. 13.

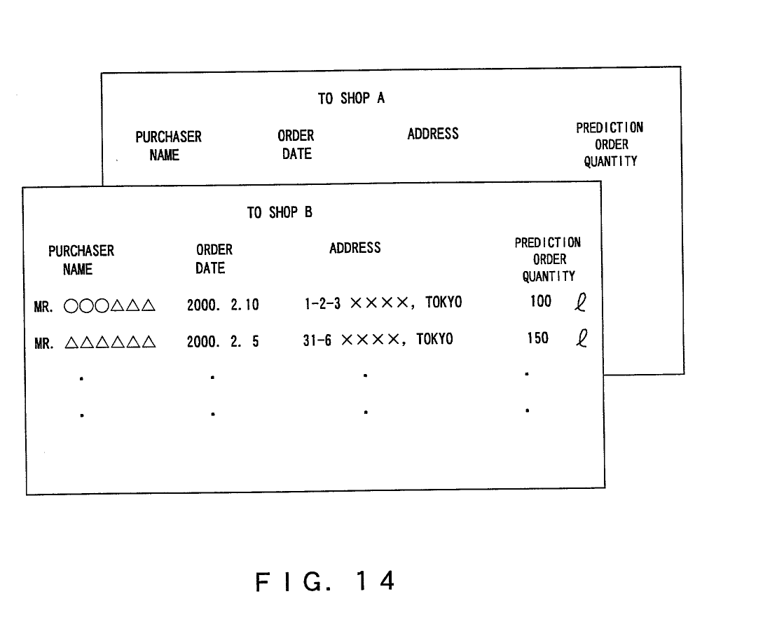

The order unit 17 refers to the order database 25 regularly, for example at a regular time every day, extracts the order information about the not-ordered merchandise a predetermined period ahead, for example one week ahead, based on the contents in the column showing that the merchandise is ordered or not (step S30), edits the extracted data for each shop Si, and prepares order information for each shop Si (step S31). FIG. 14 shows one example of order information for the shop that is prepared by the order unit 16.

The order unit 17 sends the order information prepared for each shop Si to each shop Si (step S32), and it changes the contents of the column of the order database 25 showing whether the merchandise is already ordered, to the content indicating that the merchandise is ordered (step S33). The order unit 17 writes the current purchase day in the purchase history file (step S34).

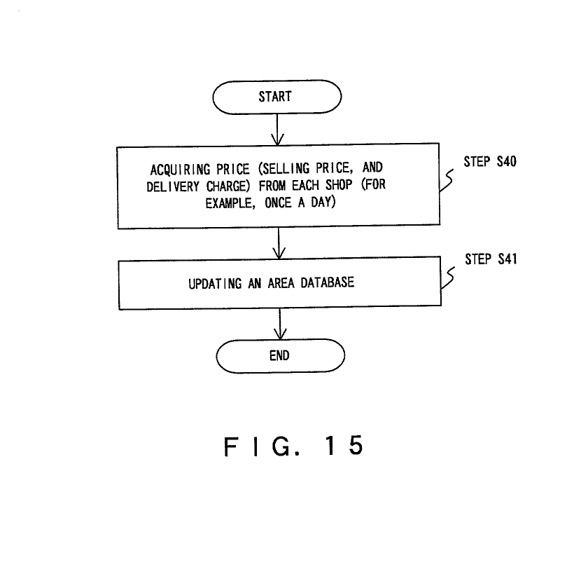

FIG. 15 is a flowchart showing processes of acquiring shop information and updating the area database 24. A process of acquiring shop information and updating an area database are explained using FIG. 15.

The shop information acquisition unit 14 acquires shop information including a merchandise selling price and delivery charge for delivering merchandise to each area within a predetermined period of time, for example this month and the next month, from each shop Si through the network N. The shop information acquisition unit 14 acquires information regularly, for example every day, or irregularity, and prepares the shop database 23 for each shop Si based on the acquired shop information (step S40). The area database updating unit 15 edits the latest shop database 23 for each area, and updates the area database 24 (step S41).

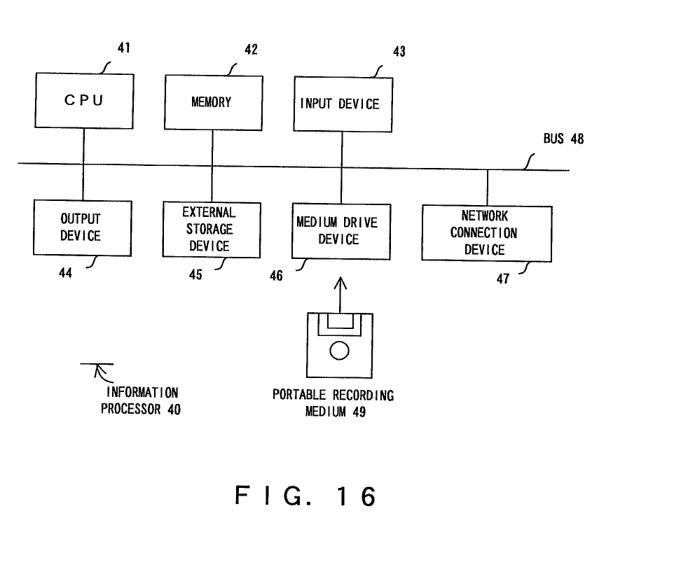

The merchandise order apparatus 10 can be configured by using the information processor (computer) as shown in FIG. 16. An information processor 40 of FIG. 16 is provided with a CPU 41, memory 42, input device 43, output device 44, external storage device 45, medium drive device 46, and network connection device 47, which are connected by a bus 48.

The memory 42 includes, for example ROM (Read Only Memory), RAM (Random Access Memory), etc., and stores programs and data to be used for processes. The CPU41 carries out a program utilizing the memory 42, thereby performing a required process.

Each piece of equipment or part that configures the merchandise order apparatus 10 shown in FIG. 2 is individually stored in a specific program code segment of the memory 42 as a program.

The input device 43 includes, for example, a keyboard, pointing device, touch panel, etc., and are used for the input of the instructions and information transmitted from a user. The output unit 44 includes, for example, a display, printer, etc., and are used for the output of the user's inquiry to the information processor 40, process results, and the like.

The external storage device 45 includes, for example, a magnetic disk device, optical disk device, optomagnetic disk device, etc. It is also possible that the above-mentioned program and data are stored in the external storage 45, and they are used if required by loading them into the memory 42.

The medium driving device 46 drives the portable recording medium 49, and accesses the recorded contents. As the portable recording medium 49, there is an optional computer-readable recording medium such as a memory card, floppy disk, CD-ROM (Compact Disk Read Only Memory), optical disk, optomagnetic disk, etc. The above-mentioned program and data are stored in the portable recording medium 49, and they are used if required by loading them into the memory 42.

The network connection device 47 communicates to an external apparatus through an optional network (line) such as a LAN, WAN, etc., and performs the data conversion associated with the communication. If required, the network connection device 47 receives the above-mentioned program and data from an external apparatus, and loads them into the memory 42 to be used.

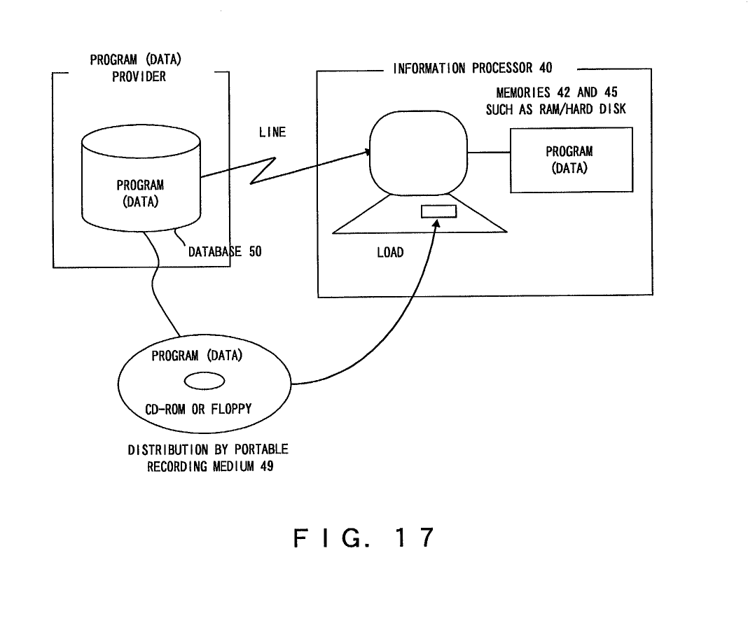

FIG. 17 shows a computer-readable recording medium that can supply a program and data to the information processor 40 of FIG. 16 and a transmission signal.

It is also possible to make a general computer perform the function corresponding to the merchandise order apparatus which is mentioned in the above-mentioned embodiments. In order to do so, the computer is configured in such a way that a program directing a computer to perform the same process as that performed by the merchandise order apparatus in each flowchart explained in the embodiments, is stored in the recording medium 49 in advance. Then, the program is read out from the recording medium 49 by the computer 40, as shown in FIG. 17, to be stored once in the memory 42 or the external storage device 45 of the computer 40. Subsequently, the stored program is read out to be executed by the CPU 41 provided in the computer 40.

Furthermore, a transmission signal to be transmitted through a line 51 (transmission medium) when the program is downloaded into the computer 40 from a database 50 of a program (data) provider, can also direct a general computer to perform the function corresponding to the merchandise order apparatus explained in the above-mentioned embodiments of the present invention.

The embodiments of the present invention are explained above, but the present invention is not limited to the above-mentioned embodiments, so that various other changes can be made.

For example, merchandise is explained citing fluid merchandise such as kerosene, etc., in the above-mentioned embodiments. The present embodiment, however, can be applied to merchandise other than fluid merchandise. For example, the present embodiments are applicable to solid merchandise such as wheat, rice, etc., since the remainder quantity of merchandise can be detected by weight.

It is explained that the shop information acquisition unit 14 acquires selling prices for this month and the next month from each shop, and the order information preparation unit 16 selects the purchase day and shop when and where the ordered merchandise can be purchased most cheaply, taking into consideration the delivery charge, within the prediction period. The shop information acquisition unit 14, however, may acquire the selling price and delivery charge every day from each shop.

In this case, the shop information acquisition unit 14 accumulates every-day selling prices of each shop for a predetermined period of time, for example one month, there by preparing the shop database 23. The area database updating unit 15 updates the area database 24 by editing the latest shop database 23 for each area.

The order information preparation unit 16 selects the purchase day and shop when and where the merchandise can be purchased most cheaply, taking into consideration the delivery charge, based on the fluctuation of the selling price in the past, in reference to the area database 24. For example, the order information preparation unit 16 selects the purchase day and shop with the following trends, by referring to the area database 24:

shop that consistently sells the merchandise most cheaply for the past one month

shop in which the selling price has been consistently falling for the past one month

bargain day of a week or a bargain date in a month is fixed, and on that day, the merchandise is more cheaply sold compared with the merchandise of the other stores In this way, it is possible to select the shop and purchase day where and when the ordered merchandise can be purchased most cheaply, and to place an order with the selected shop.

According to the present invention, regarding merchandise for which the selling price differs between every shop, it is possible to automatically place an order with the shop where merchandise can be purchased most cheaply by taking into consideration the selling price of each shop.

According to the present invention, regarding the merchandise for which the selling price fluctuates from day to day, it is also possible to automatically place an order with the shop on the purchase day where and when the ordered merchandise can be purchased most cheaply, taking into consideration the day to day selling-price fluctuation, before the merchandise is exhausted.

According to the present invention, it is possible to automatically place an order with the shop where merchandise can be purchased most cheaply, taking into consideration the delivery charge of the merchandise.

While the invention has been described with reference to the preferred embodiments thereof, various modifications and changes may be made by those skilled in the art without departing from the true spirit and scope of the invention as defined by the claims thereof.

What is claimed is:

1. A merchandise order apparatus comprising:
a receiving unit receiving an order signal including remainder quantity information that shows a remainder quantity of merchandise;
a prediction period calculation unit calculating a period until a remainder quantity of the merchandise is exhausted based on purchase history of a purchaser and the remainder quantity information;
an order information preparation unit selecting a shop where the merchandise can be purchased most cheaply, based on the calculated period and a selling price of the merchandise, and preparing order information based on the selection; and
an order unit ordering the merchandise from the selected shop based on the order information.

2. The merchandise order apparatus according to claim 1 wherein
the order information preparation unit selects a purchase day and shop when and where the merchandise can be purchased most cheaply, taking into consideration a delivery charge, within the calculated period, and
the order unit places an order with the selected shop so that the merchandise can be purchased on the selected purchase day.

3. The merchandise order apparatus according to claim 1 wherein the order information preparation unit selects the purchase day and shop by taking into consideration a fluctuation of the selling price.

4. The merchandise order apparatus according to claim 1 wherein the prediction period calculation unit calculates the period by taking into consideration a season change and the purchase history.

5. The merchandise order apparatus according to claim 1 wherein
in a case that the remainder quantity information shows that a remainder quantity of the merchandise is half, the prediction period calculation unit calculates a period M until a remainder quantity of the merchandise is exhausted, using a following equation:
M=N×K
where, N is period between a day when the unit receives the order signal and the previous purchase day, and K is a fluvtuation of a consumption pace.

6. The merchandise order apparatus according to claim 1 wherein the remainder information shows that the merchandise is exhausted, the prediction period calculation unit sets the period as a shortest period.

7. The merchandise order apparatus according to claim 1 further comprising a prediction order quantity calculation unit calculating a prediction order quantity based on the calculated period, the purchase history, and remainder quantity information, wherein
the order unit notifies the selected shop of the prediction order quantity when placing an order.

8. The merchandise order apparatus according to claim 7 wherein the prediction order quantity calculation unit calculates a prediction order quantity R using a following equation:
R=V(N+M)/2N
or
R=V(1+K)/2
where, N is a period between a day when the unit receives the order signal and the previous purchase day, K is a fluctuation of a consumption pace, M is the calculated period and V is a storage capacity of a merchandise storage container of the purchaser.

9. The merchandise order apparatus according to claim 7 wherein the prediction order quantity calculation unit sets a prediction order quantity to a storage capacity of a merchandise storage container of the purchaser, in a case that the remainder quantity information shows that the merchandise is exhausted.

10. The merchandise order apparatus according to claim 1 wherein the receiving unit receives the order signal when a remainder quantity of the merchandise becomes a predetermined quantity or when the merchandise is exhausted.

11. The merchandise order apparatus according to claim 1 wherein the merchandise is fluid merchandise.

12. A merchandise order method comprising:
receiving an order signal including remainder quantity information that shows a remainder quantity of merchandise;
calculating a period until a remainder quantity of the merchandise is exhausted, based on purchase history of a purchaser and the remainder quantity information;
selecting a shop where the merchandise can be purchased most cheaply, based on the calculated period and a selling price of the merchandise;
preparing order information based on the selection; and
placing an order with the selected shop based on the order information.

13. The merchandise order method according to claim 12 further comprising:
selecting a purchase day and a shop when and where the merchandise can be purchased most cheaply, taking into consideration the delivery charge, within the calculated period; and
placing an order with the selected shop so that the merchandise can be purchased on the purchase day.

14. The merchandise order method according to claim 12 further comprising:
calculating a prediction order quantity based on the calculated period, the purchase history, and remainder quantity information; and
notifying the selected shop of the prediction order quantity when placing an order.

15. The merchandise order method according to claim 12 further comprising calculating the period in consideration of a season change and the purchase history.

16. The merchandise order method according to claim 12 further comprising receiving an order signal when a remainder quantity of the merchandise becomes a predetermined quantity or the merchandise is exhausted.

17. A computer-readable recording medium recording a program directing a computer to control placing an order of merchandise, wherein the program includes:
receiving an order signal including remainder quantity information that shows a remainder quantity of merchandise;
calculating a period until a remainder quantity of the merchandise is exhausted based on purchase history of a purchaser and the remainder quantity information;
selecting a shop where the merchandise can be purchased most cheaply, based on the calculated period and a selling price of the merchandise;
preparing order information based on the selection; and
placing an order with the selected shop based on the order information.
